(19) United States
(12) Patent Application Publication
(10) Pub. No.: US 2003/0002769 A1
(43) Pub. Date: Jan. 2, 2003

(54) Quenching laser noise in a multimode fiber sensor system

(76) Inventors: Peter Scoot Lovely, Portland, OR (US); James N. Blake, Paradise Valley, AZ (US)

Correspondence Address: GEORGE W. FINCH, NORTH TOWER, Suite 600, 1620 26th St., SANTA MONICA, CA, 90404, US

(21) Appl. No.: 09/895,130

(22) Filed: Jun. 29, 2001

(51) Int. Cl. G02B 6/26

(52) U.S. Cl. 385/12

(57) ABSTRACT

An economical but noisy laser is made to properly operate with a multimode speckle vibration sensing system, which requires very low noise at the frequencies of the vibrations it is to sense, by reflecting a small amount of the laser light back to the laser from an optical distance larger than twice the normal coherence length of the laser.

### CROSS REFERENCE TO RELATED PATENT

This application is related to U.S. Pat. No. 4,297,684, which issued to Charles D. Butter, Oct. 27, 1981 and is entitled: Fiber Optic Intruder Alarm System and U.S. Pat. No. 5,144,689, which issued to the Peter Lovely, Sep. 1, 1992 and is entitled: Multimode Fiber Sensor System With Sensor Fiber Coupled to a Detection Fiber by Spacer Means. The teachings thereof are incorporated herein as though fully set forth below.

### BACKGROUND OF THE INVENTION

Acoustic or vibrational sensing can be done by many means. Some sensor applications benefit from a single sensor that has uniform sensitivity over a linear region, which may be quite long. There are electrical sensor systems that have uniform sensitivity over a long linear region. Typical electrical systems use coaxial cables with piezoelectric material in the space between the inner conductor and the shield so that when vibration strains the piezo electric material, the material generates voltages between the inner conductor and the shield. Another linear sensor includes a coaxial cable in which the inner conductor is loosely constrained, so that vibration causes it to move with respect to the shield, producing changes in the capacitance of the cable which can be detected by various electrical devices. When position information is not required, a constant voltage is applied to the cable and current fluctuations are observed. If position information of the vibration along the sensing cable is to be determined, then commercially available devices such as time domain reflectometers can be used to sense both capacitance variations and where they are occurring.

There also are several ways to provide linear sensing using light passing through optical fiber. Optical fiber has certain advantages, including high sensitivity, robustness, immunity to electrical disturbances, and the fact that it cannot emit electrical disturbances nor can its position be sensed by passive means. One important application of a linear vibration sensor is intrusion sensing, which will be used as the primary example below.

One fiber-optic method for intrusion sensing or general vibrational sensing incorporates a Sagnac interferometer. An intrusion sensor using this principle was commercialized by Mason and Hanger. Another fiber-optic method entails multimode speckle sensing as described in U.S. Pat. No. 4,297,684, which was issued Oct. 27, 1981 to Charles D. Butter, entitled: Fiber Optic Intruder Alarm System. An intrusion sensor of this type was commercialized by Fiber SenSys Inc. in 1991 as Fiber SenSys Models M105 and M106, and then later as Models FD205, FD206, FD220. The speckle approach costs less, partly because it does not require fiberoptic splitters. It uses multimode fiber for sensing, which is generally easier to connectorize than the single-mode fiber used in Sagnac sensor systems. Furthermore, the Sagnac sensor that has been marketed requires two sections of fiber covering the sensing zone, in order to compensate for the awkward fact that the sensitivity of the fiber is not uniform, but instead varies significantly along its length.

In the multimode speckle method, sensitivity to vibration is uniform along the length of the sensing fiber. A laser is generally used for the light source, because high optical coherence is required. The speckle sensor depends on interference between different optical modes in the multimode fiber. The interfering modes create a random speckle pattern that varies when the sensing fiber experiences vibration, and the variations in the pattern can be detected by various means. One class of detection means involves restriction of the light so that only a portion of it reaches a detector, and measurement of variations in the signal from the detector. A number of methods for achieving such restriction are discussed in the aforementioned U.S. Pat. Nos. 5,144,689 and 4,297,684, and also in U.S. Pat. No. 4,843,233 by Jeunhomme. For the different optical modes in the multimode fiber to interfere with sufficient contrast, the coherence time of the light source must be longer than the typical differences in propagation delay between different optical modes over the length of the sensing fiber. This is an ideal explanation of the principle that only approximates reality. The question of whether a laser source is coherent enough usually must be answered by empirical experiments, because the interaction of the modes is complex, and the signal depends on the mixture of modes into which the light is launched, the length of the optical sensor fiber, and how the changing speckle pattern is converted into a signal. Generally, the sensitivity of such a sensor decays as the length of the optical sensor fiber becomes longer, because the inter-modal delays become longer than the source's coherence length. This is of particular concern when the sensing fiber is long, such as in intrusion sensing applications, where the desired length may be several kilometers.

Available multimode speckle sensor systems are very sensitive to any spectral noise of the laser light source. Therefore, it is necessary to use a laser that is very quiet in certain aspects of its operation. Specifically, the wavelength (or the distribution of wavelengths) of the laser light source must be stable in the frequency range that is to be detected. This may be 10 Hz to 1000 Hz for intrusion sensing, and higher in the audio frequencies for other applications. Wavelength stability is required because a very small shift in the wavelength causes the speckle interference pattern to shift, just as it does when the sensing fiber is being subjected to vibrations caused by intrusions, creating false signals.

Lasers that are both quiet and inexpensive are very difficult to find. Generally, low cost is achieved by finding a laser that is produced for a high-volume applications such as optical communications or CD players. However, low-frequency spectral noise does not matter in these applications, and even DFB (distributed feedback) lasers, with very low noise and narrow line width specifications for telecommunications, have intolerable low-frequency spectral noise when used in speckle sensor applications.

Early multimode speckle sensors were made using helium-neon lasers, which are not practical commercially. The products of Fiber SenSys, Inc., mentioned above, have used a commercially available inexpensive CD laser that although not specified nor required for the intended application, happened to have low spectral noise of the sort that matters for a multimode speckle sensor. Its low noise is believed to have been an accident of the design. Other CD lasers, with similar specifications, have spectral noise that is intolerable for multimode speckle sensing. One usable laser has now been discontinued, making it necessary to find a substitute when constructing a multimode speckle sensor. Unfortunately, almost all commercially available diode lasers, CD lasers, and telecommunications lasers have intolerable low-frequency spectral noise. This includes frequency-stabilized devices such as DFB lasers, which have low enough high-frequency spectral noise for telecommunications, but are still too noisy at low frequencies for multimode speckle sensor applications.

A method, unrelated to multimode speckle sensing applications, for broadening the optical spectrum of a laser is described in U.S. Pat. No. 5,608,524, issued Mar. 4, 1997, entitled, “Coherence Collapsed Multimode Source for a Fiber Optic Gyro,” by James N. Blake; and in a paper entitled, “Coherence-Collapsed 1.3 nm Multimode laser diode for the Fiber-optic Gyroscope,” by I. S. Kim, P. Tantaswadi and J. Blake, published in Optics Letters, Vol. 20, No. 7, pp. 731-733, Apr. 1, 1995. The purposes expressed for such a method are: to make the spectrum broad so that a depolarizer can be used effectively; and to suppress noise problems that are caused by uncontrolled small reflections in the fiber assembly of a fiber-optic gyroscope. The Blake invention enabled an inexpensive higher-power laser to be used in applications that were previously served only by lower-power edge-emitting light-emitting diodes, superluminescent diodes, and other specialized sources, all of which have very broad, incoherent spectra. The Blake broadening method uses a large reflection (18%), at a moderate distance of at least two coherence lengths of the unbroadened laser, to put the laser into the “coherence collapse” condition. This is described (for a different kind of laser) in a paper titled “Regimes of Feedback Effects in 1.5-μm Distributed Feedback Lasers” by R. W. Tkach and A. R. Chraplyvy, published in the Journal of Lightwave Technology, Vol. LT-4, No. 11, pp. 1655-1661, November 1986.

### SUMMARY OF THE INVENTION

The present invention is a method of stabilizing a laser so that its spectrum is adequately quiet, but still coherent enough, for multimode speckle sensing.

In the present invention, the Blake broadening method discussed above, using up to approximately 20% reflection (and in most cases much less reflection) at a moderate distance of at least several coherence lengths of the unbroadened laser to put the laser into the “coherence collapse” condition, is incorporated into a multimode speckle sensor. Heretofore, reflection-induced coherence collapse did not appear useful in multimode speckle sensors because such a process significantly broadens the spectrum of a laser and thereby shortens its coherence length, and because such reflections generally are known to create noise. Contrary to these expectations, the present invention is based on the empirical discoveries that: even though spectral noise is increased at higher frequencies, an appropriate reflection can reduce low-frequency spectral noise in a laser to levels adequate for multimode speckle sensors; and such reflection does not broaden the spectrum so much as to make the laser too incoherent for use in multimode speckle sensing applications.

The reflection-induced coherence collapse technique can be used on a laser with a single spectral line, such as a DFB laser, or on a laser with multiple modes. In the latter case, the multiple lines are generally incoherent with each other, so each line generally produces its own interference pattern, and the signals from individual lines add incoherently. The reflection then has the effect of stabilizing each individual line. In addition, the reflection can reduce the low frequency component of any mode partition noise that may exist.

### BRIEF DESCRIPTION OF THE DRAWINGS

FIG. 1 is a schematic of a fiber optic sensing system in accordance with the present invention, with gap restriction means;

FIG. 2 is a schematic of an alternative embodiment of the inventive fiber optic sensing system, with solid restriction means;

FIG. 3 is a schematic of a fiber optic sensing system in accordance with the present invention, with fiber gap restriction means;

FIG. 4 is a partial view of the interface between a multimode fiber and a single mode fiber;

FIG. 4A is a greatly enlarged partial cross-sectional view of the interface between a multimode fiber and a single mode fiber;

FIG. 5 is a graph of the total detected acoustic power versus time and the alarm output from a multimode speckle sensing system using a standard 1310-nm DFB laser;

FIG. 6 is a graph of the detected acoustic power per unit of bandwidth as a function of frequency averaged over the 0.5 sec. time interval between the solid and dashed lines of FIG. 5;

FIG. 7 is a graph of the total detected acoustic power versus time and the alarm output as in FIG. 5, except that the laser is stabilized in accordance with the present invention, and the sensing system is being bumped gently by the operator to create alarms; and

FIG. 8 is a graph of the detected acoustic power per unit of bandwidth as a function of frequency averaged over the 0.5 second time interval between the solid and dashed line of FIG. 7.

### DETAILED DESCRIPTION OF THE INVENTION

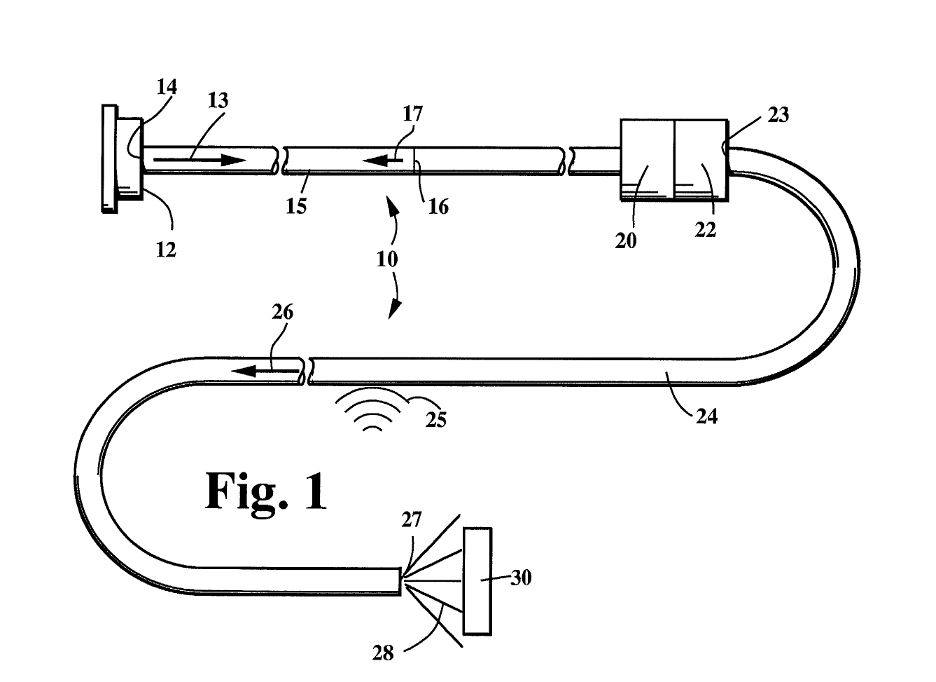

Referring to the drawings, more particularly by reference numbers, number 10 in FIG. 1 refers to an intrusion sensing system constructed according to the present invention. Although the following descriptions are fiber based embodiments, since presently such are the most economical to produce, the invention can be embodied in bulk optics or any other optical transmission means that prove to be economical or advantageous in the future. The system 10 includes a laser 12 (such as a diode laser), which preferably is of the low noise variety. However, as discussed above, economical lasers 12 tend to be those manufactured for mass uses where low noise characteristics of the correct type required for a multimode speckle sensing system 10 is not important so that such quiet lasers presently are not available. The laser 12 inserts a light beam 13 directly or through a lens or other well known coupling means (not shown) into the end 14 of an optical fiber 15 (which may be multimode or single mode and is not required to be polarization preserving), which has a reflector 16 incorporated there along to send a portion 17 of the beam 13 back into the laser 12. Preferably the optical fiber 15 is at least a couple of normal coherence lengths long, “normal” coherence length being the coherence length of the laser 12 with no appreciable external reflection being reflected back to the laser 12. The reflector 16 has been shown to require a reflection value of from 0.5% to 20% depending upon the laser 12 being used. For example, certain 1310 nm DFB lasers have been shown to require between a 2% and 10% reflection to provide the needed reflection-induced coherence collapse described in U.S. Pat. No. 5,608,524 discussed above. The preferred optimum reflection amount with a specific laser model at this point is not absolutely predictable, but instead has been empirically determined. For example some strange instabilities, that are not understood arose at 16% with one laser and although reflections as low as 0.5% may work fine in some instances, such might not be the “dominant” reflection in the fiber assembly, i.e. less than 2% reflections produce similar reflected power as other small unavoidable reflections at different distances in some systems. The use of a small reflection to quiet outputs in the low audio frequencies even in the expected reflection percentage range works better with some commercially available lasers than others.

The reflector 16 can be constructed with free space optics or other known means, but the in-fiber method is preferred. Such a fiber method is described by C. E. Lee and H. F. Taylor in Electronic Letters volume 24, page 193 (1988). Small air gaps can be used to generate a reflection and this may done as simply as backing out a connector joint a small amount. However, this may lead to an uncontrolled reflection value, because the reflected power depends on the exact spacing, which determines whether there is constructive or destructive interference between the reflections from the two fiber ends. Reflections can also be made by coupling an angled connector ferrule to a non-angled one (not shown). This eliminates the interference effect, and causes a controlled space between the ends. It is best to have the non-angled connector ferrule on the side of the laser 12, so that a good reflection occurs from the perpendicular surface. Then the second surface at the opposite side of the air gap is angled, so it does not reflect back towards the laser 12. If the angled end were on the side of the laser 12, the reflection from the perpendicular end would be from the other side of the air gap and might be both diminished and less controlled.

The optical fiber 15 is terminated at a connector 20 which connects to a like connector 22 on an end 23 of a multimode sensing fiber 24. Vibrations 25 impinging on the sensing fiber 24 affect the light beam 26 therein, which started out as light beam 13, minus light beam portion 17 and any loss created by connectors 20 and 22 and in the fibers 15 and 24. The light beam 26 expands and is projected out of the end 27 of the sensing fiber 24, and a portion 28 strikes a restrictive detector 30. A typical restrictive detector 30 is spaced from the end 27 and sized so that only the portion 28 of the beam 26 impinges thereon. An interference pattern or “speckle” pattern in the beam 26 is caused by interference between portions of the beam 26 that take different paths as they pass through the fiber 24. Such speckle pattern is changed by vibrations, such as produced by an escapee trying to walk on ground in which the sensing fiber 24 is embedded, or climbing a barrier, such as a fence, which includes the sensing fiber 24. the portion 28 of the light beam 26 is projected onto the plane of the detector 30. This can be accomplished by having the field of view of the detector 30 less than the total beam 26, by partially offsetting the detector 30 from the path of the beam 26, or by any other convenient method. Restriction is accomplished because the restrictive detector 30 gathers light from only a partial region of this plane. Since the vibrations applied to the sensing fiber 24, change the multimode characteristics thereof, the optical power in the portion 28 of the light beam 26 changes, even though the total optical power of the light beam 26 emerging from the end 27 does not change appreciably due to vibrations applied to the sensing fiber 24.

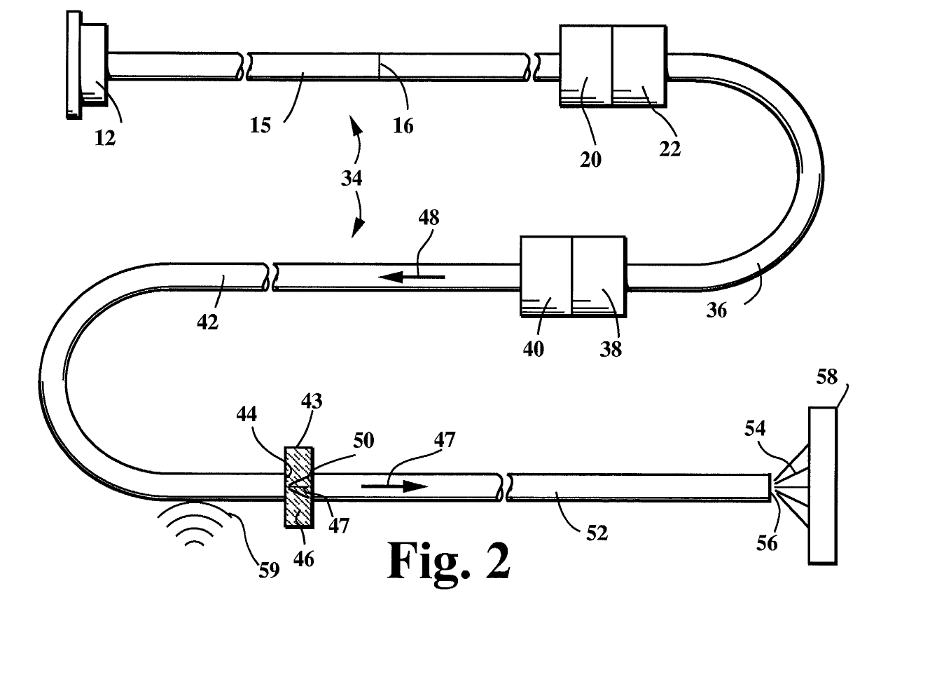

A modified version 34 of the system 10 is shown in FIG. 2. It includes an optical fiber lead 36 (preferably single-mode so it is insensitive to vibrations), which may be very long, extending from connector 22 to connector 38 which is, in turn, connected to connector 40 to connect a multimode or single-mode sensing fiber 42 thereto. The multimode sensing fiber 42 is terminated by a restrictor 43 positioned at the end 44 thereof. The restrictor 43, as shown in FIG. 2, includes a light transmissive spacer 46 which connects a portion 47 of the light beam 48 to an end 50 of a multimode fiber return lead 52. The resultant light beam 54 projects out of the end 56 of the multimode fiber 52 onto a large, that is, non-restrictive detector 58. The portion 47 varies with vibrations 59 that impinge on the sensing fiber 42. Since all of the light in the beam 47 is collected by the detector 58, the return lead 52 is insensitive to vibrations.

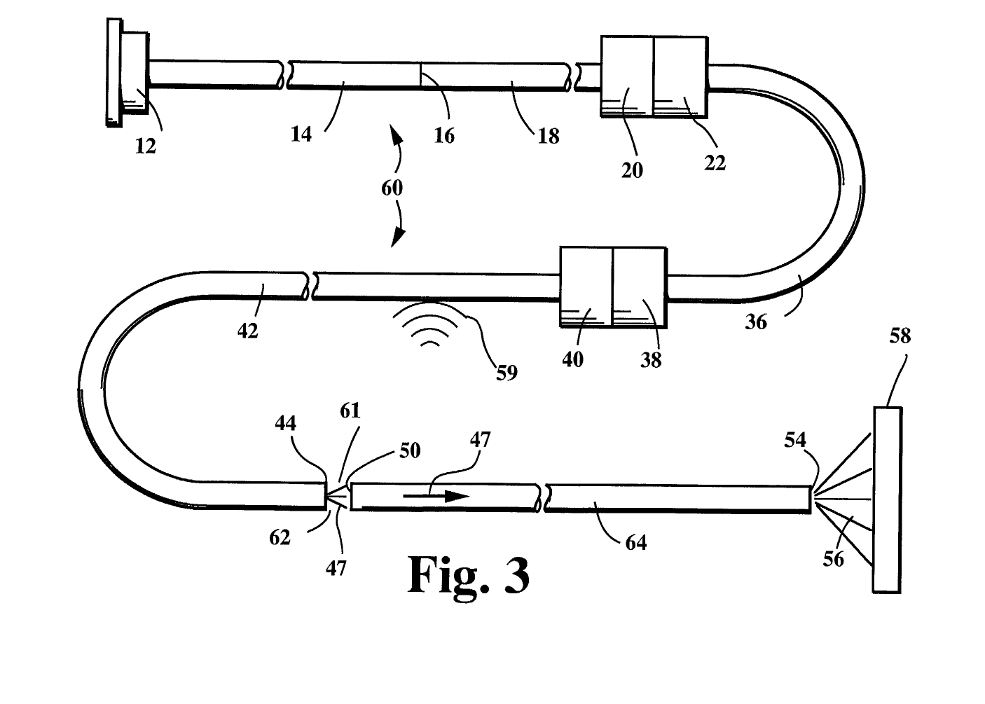

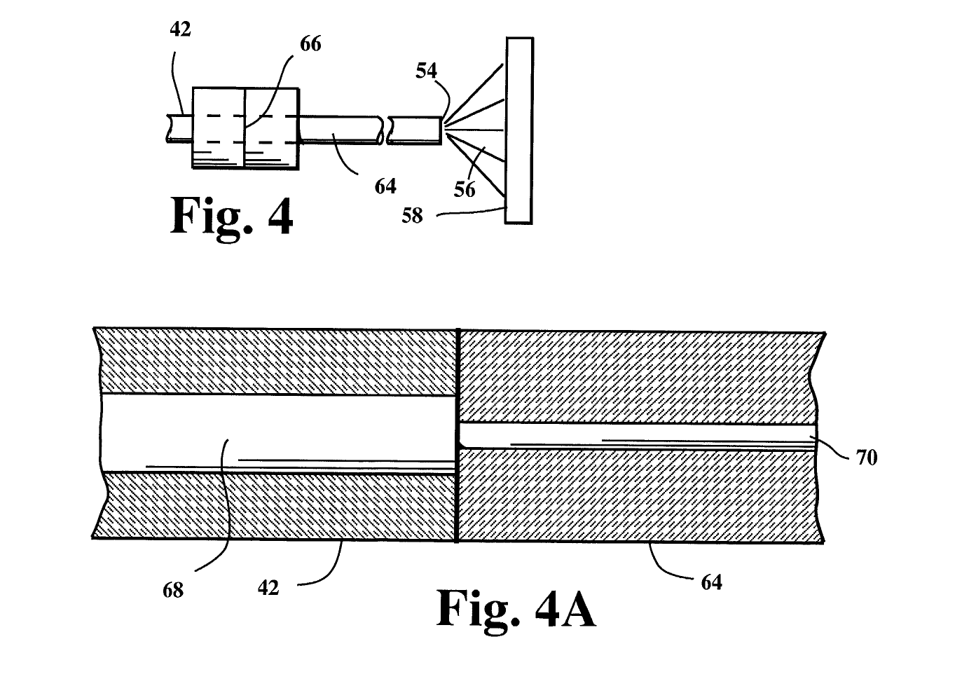

As shown with system 60 in FIG. 3, the restrictor 43 of FIG. 2 may be a restrictor 61 with an air gap 62, or it can be eliminated altogether when the return fiber 64 is a single-mode fiber, as single mode fibers generally have much smaller core diameters than multimode fibers. In this latter case, the needed restriction is accomplished by an interface 66 between the single-mode fiber 64 and the multimode fiber 42, as shown in FIG. 4 and in more detail in FIG. 4A. Note that the core 68 of the multimode fiber 42 has a much larger diameter than the core 70 of the single mode fiber 64, thereby producing restriction of any light beam passing from the core 68 to the core 70 In certain applications, it may be desirable to have a single mode fiber as a return fiber even with a formal restriction such as restrictors 46 and 61. At one time there was a substantial price differential between single mode and multimode fibers making single mode fibers too expensive for economical systems. The high volume usage of single mode fibers and the lower quantity of dopant has made single mode fibers more economical so it is now desirable to substitute single mode fibers for multimode fibers where possible.

The result of all of the shown embodiments is that an economical intrusion detector, either buried or strung along a barrier, and other types of sensors using relatively long sensing fibers whose response to vibrations are uniform along the length of the sensing fiber may be constructed economically. That is even though the number of such systems with similar applications do not warrant the expense of a special laser design with the required low noise level at low audio frequencies.

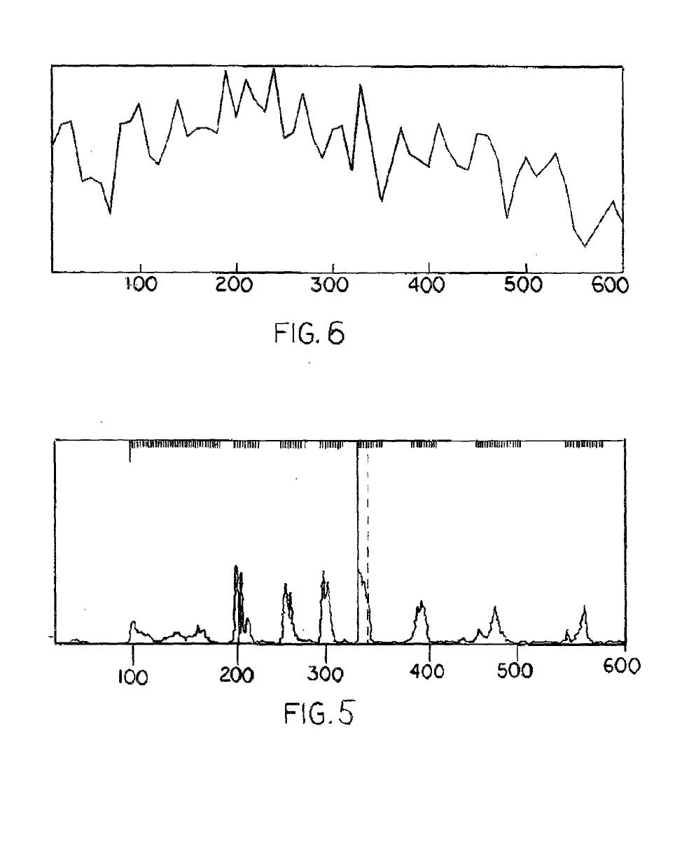

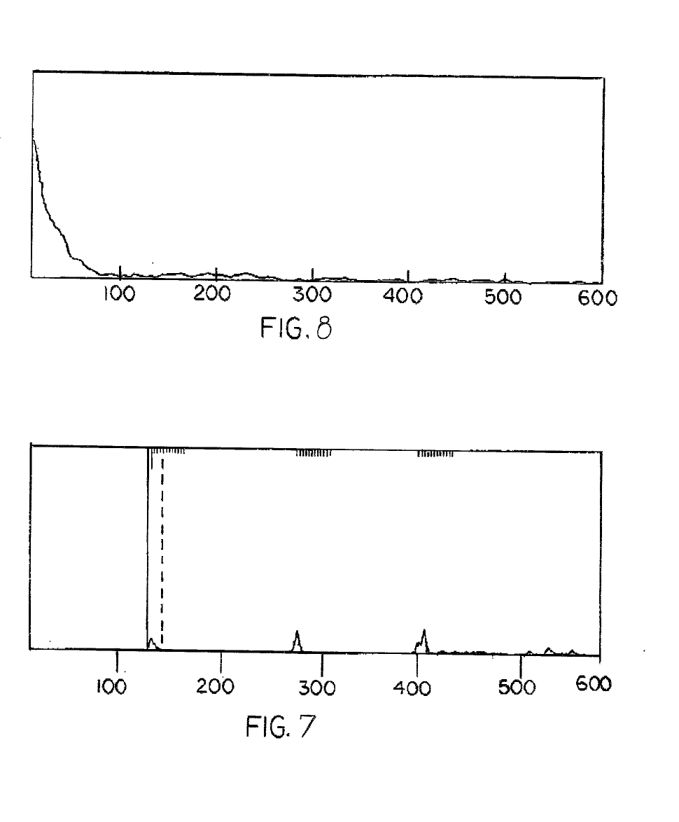

The difference in noise can be seen by comparing FIGS. 5 and 6 with FIGS. 7 and 8. FIG. 5 is a graph of the total detected acoustic power versus time and the alarm output of a standard 1310-nm DFB laser in a multimode speckle sensing system. FIG. 6 shows, in graphical form, the detected acoustic power per unit of bandwidth as a function of frequency averaged over the 0.5 second time interval between the solid and dashed lines of FIG. 5. Note the noise and the alarms the noise causes, as shown by the lines at the top of FIG. 5.

FIG. 7 is a graph of the total detected acoustic power versus time and the alarm output as in FIG. 5, except that the laser is stabilized in accordance with the present invention, and the sensing system is being bumped gently by the operator to create alarms. FIG. 8 is a graph of the detected acoustic power per unit of bandwidth as a function of frequency averaged over the 0.5 second time interval between the solid and dashed line of FIG. 7. FIG. 7 shows that alarms are only being produced in response to the aforementioned “bumps”. The acoustic power in the problematic noise of FIG. 5 is higher than the acoustic power in the bumps detected in FIG. 7, showing the need for noise reduction.

Thus there have been shown and described novel fiber optic intrusion alarm systems and method for quieting a laser at low frequencies, which fulfill all of the objects and advantages sought therefor. Many changes, modifications, alterations and other uses and applications which do not depart from the spirit and scope of the invention are deemed to be covered by the invention which is limited only by the claims which follow.

1. A vibration sensing system for sensing vibration at certain vibration frequencies including:
a laser which produces a first light beam which normally would have undesirable noise at the vibration frequencies to be sensed;
a first optical assembly positioned to receive the first light beam, said first optical assembly including:
reflection means to reflect back a portion of the first light beam to said laser as a second light beam to reduce the noise at the vibration frequencies to be sensed, produced by said laser, thereby splitting the first light beam into the second light beam and a third light beam; and
a second optical assembly connected to receive the third light beam from said first optical assembly, said second optical assembly including:
a multimode sensing fiber connected to allow the third light beam to conduct there through, whose multi-modes cause an interference produced speckle pattern to be created from the third light beam that varies in pattern with vibrations impinging on said multimode sensing fiber; and
means to detect variations in the interference produced speckle pattern to thereby determine the vibrations impinging on said multimode sensing fiber.

2. The vibration sensing system as defined in claim 1 wherein said means to detect variations in the interference produced speckle pattern include:
means for detection of the optical power in a portion of the third light beam.

3. The vibration sensing system as defined in claim 1 wherein said means to detect variations in the interference produced speckle pattern include:
an end on said multimode sensing fiber which projects the interference produced speckle pattern in a fourth light beam; and
a light detector positioned to detect a portion of the fourth light beam and determine variations in intensity thereof representative of the vibrations.

4. The vibration sensing system as defined in claim 1 wherein said means to detect variations in the interference produced speckle pattern include:
an end on said multimode sensing fiber which projects the interference produced speckle pattern in a fourth light beam;
a solid, light transparent member through which the fourth light beam is projected;
a return fiber positioned opposite said multimode sensing fiber positioned with respect to said solid, light transparent member to receive a portion of the fourth light beam; and
a light detector positioned to detect the portion of the fourth light beam in said return fiber and determine variations in intensity thereof representative of the vibrations.

5. The vibration sensing system as defined in claim 1 wherein said reflection means reflect back from 0.5% to 20% of the first light beam to said laser.

6. The vibration sensing system as defined in claim 1 wherein said reflection means reflect enough of the first light beam back to said laser to cause reflection-induced coherence collapse.

7. The vibration sensing system as defined in claim 1 wherein said laser has:
a normal optical coherence length before light is reflected back thereto, and wherein said reflection means reflect said second light beam back from an optical distance at least two of said normal optical coherence lengths from said laser.

8. The vibration sensing system as defined in claim 1 wherein said means to detect variations in the interference produced speckle pattern include:
an end on said multimode sensing fiber which projects the speckle pattern in a fourth light beam;
a gap across which the fourth light beam is projected;
a return fiber positioned opposite said multimode sensing fiber across said gap to receive a portion of the fourth light beam; and
a light detector positioned to detect the portion of the fourth light beam and determine variations in intensity thereof representative of the vibrations.

9. The vibration sensing system as defined in claim 1 wherein said multimode sensing fiber is buried along a path where disturbances produce vibrations in the frequency range of 10 to 1000 Hz.

10. The vibration sensing system as defined in claim 9 wherein said reflection means reflect back from 0.5% to 20% of the first light beam to said laser, and wherein said laser has:
a normal coherence length before light is reflected back thereto, and wherein said reflection means reflect the second light beam back from an optical distance at least two of said normal coherence lengths from said laser.

11. The vibration sensing system as defined in claim 1 wherein said multimode sensing fiber is strung along a barrier where disturbances produce vibrations in the frequency range of 10 to 1000 Hz.

12. The vibration sensing system as defined in claim 11 wherein said reflection means reflect back from 0.5% to 20% of the first light beam to said laser, and wherein said laser has:
a normal coherence length before light is reflected back thereto, and wherein said reflection means reflect the second light beam back from an optical distance at least two of said normal coherence lengths from said laser.

13. The vibration sensing system as defined in claim 1 wherein said means to detect variations in the interference produced speckle pattern include:
a single mode fiber connected to said multimode sensing fiber to receive a portion of the speckle pattern created from the third light beam that varies in pattern with vibrations impinging on said multimode sensing fiber.

14. The vibration sensing system as defined in claim 1 wherein said multimode sensing fiber includes:
an end which projects the speckle pattern in a fourth light beam, and wherein said means to detect variations in the interference produced speckle pattern include:
a single mode fiber to act as the restriction positioned to collect a portion of the speckle pattern in the fourth light beam.

15. The vibration sensing system as defined in claim 1 wherein said multimode sensing fiber includes:
a core of a first cross-sectional area; and
an end which projects the speckle pattern in a fourth light beam, and wherein said means to detect variations in the interference produced speckle pattern include:
a fiber having:
a core of a second cross-sectional area smaller than the first cross-sectional area, said cores being butted against each other, whereby said core of the second cross-sectional area acts as the restriction.

16. A coherent laser system whose output is quiet from noise at a range of audio frequencies including:
a laser which produces a first light beam with undesirable noise at the range of audio frequencies;
a first optical assembly positioned to receive the first light beam, said first optical assembly including:
reflection means to reflect back a portion of the first light beam to said laser as a second light beam to quiet the noise at the range of audio frequencies produced by said laser, thereby splitting the first light beam into the second light beam and a third light beam, wherein the third light beam is quiet from noise at the range of audio frequencies.

17. The system as defined in claim 16 wherein said reflection means reflect back from 0.5% to 20% of the first light beam to said laser, said laser having:
a normal optical coherence length before light is reflected back thereto, and wherein said reflection means reflect back the second light beam from a distance that is at least two of said normal optical coherence lengths from said laser.

18. The system as defined in claim 16 wherein said reflection means reflect back from 0.5% to 20% of the first light beam to said laser.

19. The system as defined in claim 16 wherein said reflection means reflect enough of the first light beam back to said laser to cause reflection-induced coherence collapse.

20. The system as defined in claim 16 wherein said laser has:
a normal optical coherence length before light is reflected back thereto, and wherein said reflection means reflect back the second light beam from a distance that is at least two of said normal optical coherence lengths from said laser.

21. An economical method for quieting audio noise in the light output of a diode laser, the diode laser having a normal optical coherence length, the method including:
reflecting from 0.5 to 20% of the light output of the diode laser back to the diode laser from an optical distance of at least two normal optical coherence lengths.

22. The method as defined in claim 21 wherein said reflecting is along an optical fiber.

23. The method as defined in claim 21 wherein the optical noise to be quieted is in the range of 10 to 1000 Hz.
